(19) United States
(12) Patent Application Publication
(10) Pub. No.: US 2005/0072726 A1
(43) Pub. Date: Apr. 7, 2005

(54) Filter for phase separation

(76) Inventor: Wolfgang Laub, Umkirch (DE)

Correspondence Address: DAVID A. GUERRA, 933 OLANDER WAY SOUTH, SUITE 3, SOUTH PASADENA, FL, 33707, US

(21) Appl. No.: 10/500,940

(22) PCT Filed: Jan. 9, 2002
(86) PCT No.: PCT/DE02/00029

(51) Int. Cl. B01D 29/00

(52) U.S. Cl. 210/330; 210/331; 210/488; 210/486

(57) ABSTRACT

The invention relates to a filter for fluids displays a number of film elements (1) stacked on top of each other, showing central perforations (2) aligned with each other. In order to simplify the manufacturing, the film elements (1) of neighboring stacks (4) on the same level are connected to each other by connecting fillets. Hence the filter elements (1) form an inherently stable matrix which can be easily stacked.

The invention concerns a filter for phase separation according to the generic term of claim 1.

The separation can take place especially between the solid-liquid as well as solid-gas phases, but in theory even between different or identical phase combinations.

These types of so-called marginal column filters are employed in particular in the cleaning of polluted cooling lubricants. Generally so-called filter cartridges are utilized. The basic theory is that film rings in paper, metal plastic or ceramics are fixed on tube-shaped metal core having, for example, a square cross-section. The fluid to be cleaned flows from the outside through the intermediate areas between the layers, whereby the particles stick to the outside and form the so-called filter cake. The filtered liquid then flows into the space between the inner sheath surface of the film stack and the outer sheath surface of the tube to one end of the tube and subsequently within the tube in the opposite flow direction to the exit. Perforated tubes may be used in alternative.

In the case of the marginal column filters it is of particular interest to achieve a certain degree of filtration as well as a relatively high filter surface per reconstructed volume. As these marginal column filters consist in a number of film elements stacked on top of each other, there is a tendency to develop these elements as thin as possible, so as to achieve an ideal ratio between the open and closed surfaces. In the case of very fine filters a series of additional ring-shaped elements are punched out of film which are then sometimes broken out and which then must be stacked on the previously mentioned metal bar. The resulting filter cakes can consist for example in 6.000 elements with a film thickness of 0.1 mm. Hence the lengths of the filter cartridge can generally vary from 10 to 100 cm.

The disadvantage with this known marginal column filter is that a considerable number of single film elements must be stuck on to a number of metal bars in order to create the matrix-like arranged filter cartridges. This is technically quite complex in terms of production.

Having premised this, the purpose of the invention is to offer an easier means of manufacturing a filter of the aforementioned kind.

The technical solution is distinguished by the features pointed out in claim 1.

The basic idea underlying the invention of the marginal column filter consists in the fact that film rings are connected together in a matrix right from the beginning by means of specifically conceived connecting fillets. These matrixes are stacked in their entirety. Therefore it is no longer necessary to punch out single elements in order to process these, but almost the complete filter block is punched out of the film as matrix, while the elements are connected among themselves by means of thin fillets. As a result in a single punching procedure a very big matrix consisting in many film elements can be made; as the latter are already in place, the creation of large filter surfaces is considerably simplified. Hence it is no longer necessary to punch out or collect the film elements. The stacking is also more effective, as the element matrixes can be stacked on top of each other. In addition, large filter surfaces can be achieved with few or no metal rods as opposed to the many metal rods assigned to the filter cartridges in other procedures. The creation of an entire filter without guiding tubes is also possible. This procedure also allows for the creation of countless customized sizes. This would not be easy to achieve if single elements were employed without any connection between them. As a result the filter can increase considerably in efficiency. Furthermore the production costs for filter systems can be considerably reduced, as the construction sizes can be lowered; otherwise filter systems could be made much more efficient at equal cost. Through the specific production technology subject of this invention it is furthermore possible to create very fine constructions and very thin film can be employed. Furthermore the microtechnology allows for the blowing out of dirty channels between the ring stacks of the film elements. In addition the clean oil conduct as well as the regeneration channels and lastly the air channels can be incorporated into the cover plate.

Basically it can be hypothesized that partial surface areas can be created by means of inherently stable filter matrixes. According to the development in claim 2, it is however suggested that all film elements on the same level be connected with each other by means of connecting fillets. Therefore the entire filter cross-section is formed through the stacking of appropriately dimensioned matrixes.

The development according to claim 3 suggests a special arrangement of the film elements as well as the connecting fillets merely as an example. Different arrangements are conceivable for a variety of execution forms, for example triangular arrangements or even star-shaped arrangements.

As already mentioned, according to the development set out in claim 4 the film elements as well as the connecting fillets are punched out of one film sheet. Therefore in the case of the film matrix we are dealing with a one-piece formation.

And lastly the development according to claim 5 suggests that the stacks with their film elements can be pressed together. This offers a technically simple possibility of regulating the fineness of the filter. As a consequence the filtering strength can be modified by means of regulating the pressure on the matrix stack.

An example of execution of the filter object of the invention is subsequently described by means of the drawings. These show:

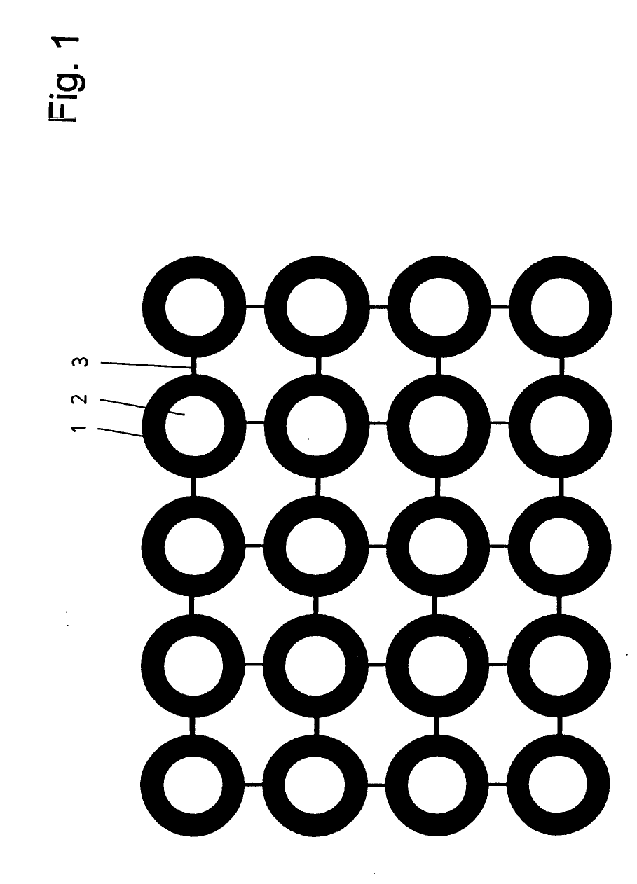

FIG. 1 a view of a matrix of film elements

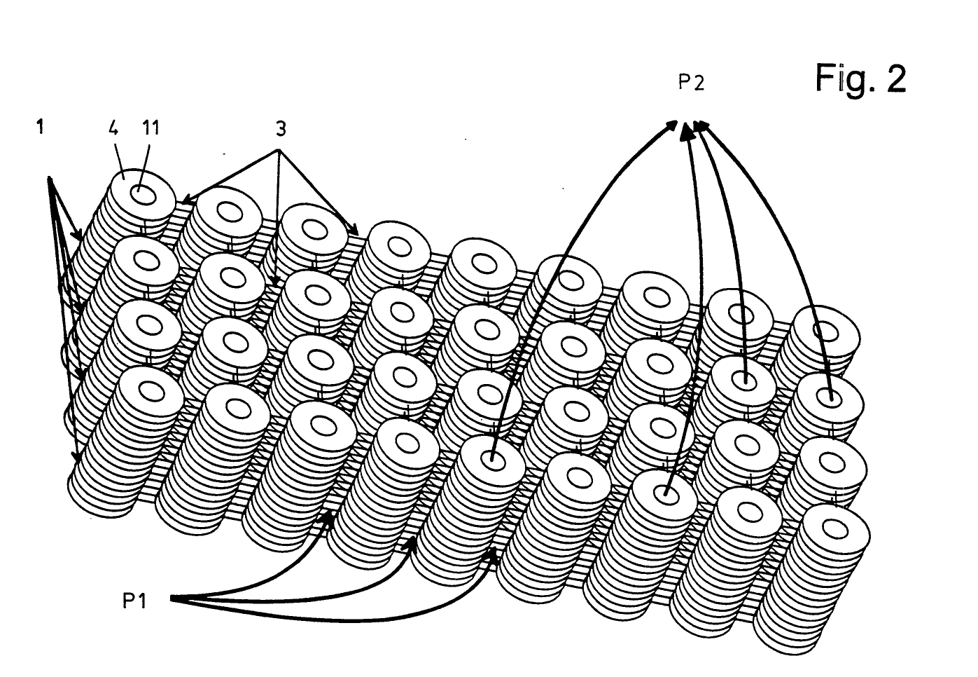

FIG. 2 a view in perspective of the filter with matrixes stacked on top of each other

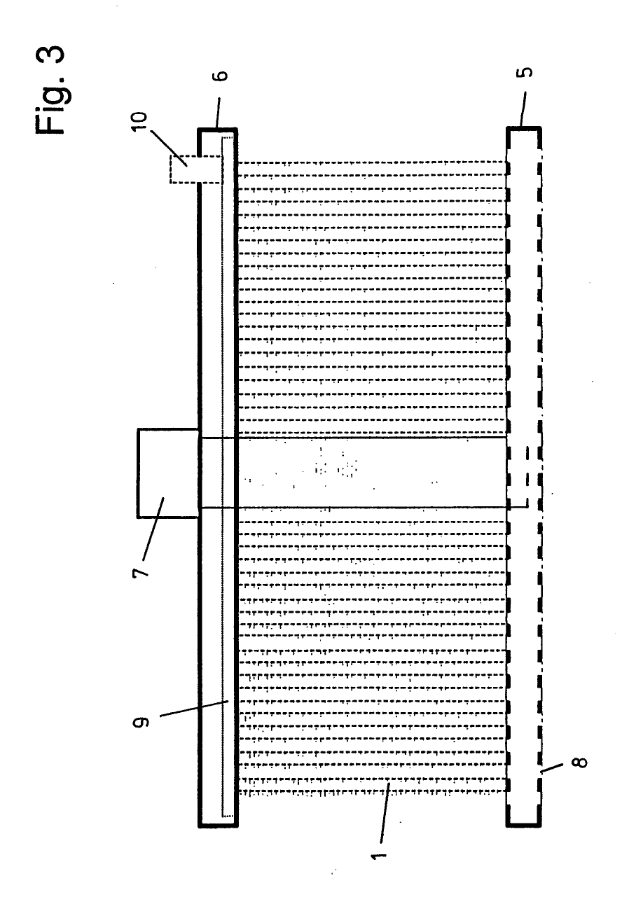

FIG. 3 a cross-section through the filter with the additional possibility of regulating the filter strength

FIG. 1 shows a number of round film elements 1, which each display a concentric equally round perforation 2. These film elements 1 are connected by means of connecting fillets 3. The entire formation as it is illustrated in FIG. 1 is punched out of one film sheet.

FIG. 2 shows that a number of these matrixes of film elements 1 connected by means of connecting fillets 3 are stacked on top of each other. The thickness of the film is shown here in a slightly exaggerated way. Depending on the number of film elements 1 per matrix, a corresponding number of stacks 4 are formed. Any kind of centering or fixing device for the matrixes is not explicitly shown here. It could also be hypothesized that a metal rod could be running through the film elements 1 in the four corner points of the matrix.

Lastly, FIG. 3 shows in a schematic cross-section illustration, that the lower side and the upper side of the stacks 4 are formed by a base plate 5 as well as a cover plate 6. Between these two plates 5,6 a preloading device 7 is provided for. In addition the base plate 5 is equipped with guiding channels 8 for the dirty phase, and the cover plate 6 is equipped with guiding channels 9 for the filtered phase. The cover plate 6 is also outfitted with an outlet for the cleaned fluid.

The method of functioning is as follows:

The fluid to be cleaned is fed to the filter by flowing externally around the stacks 4. This is indicated by the arrows P1. The fluid flows from the outside through the intermediate spaces between the layers. The substances to be filtered out are deposited on the outside of the stack 4 of the film elements 1 as a so-called filter cake. The fluid cleaned in this manner flows into the channel 11 formed by the perforations 2 of the film elements 1 and flows out as cleaned fluid. This is indicated by the arrows P2.

By operating the preloading device 7 the pressure on the film elements 1 can be modified, thus regulating the fineness of the filtering process.

1-5. (canceled)

6. A filter for phase separation, comprising: a plurality of film elements stacked on top of each other showing central perforations aligned with each other, whereby several stacks are arranged in parallel as well as matrix-like fashion to each other, while film elements of neighboring stacks lie on a common level connected to each other by means of connecting fillets, and whereby the phase to be filtered flows from the outside through spaces in between neighboring film elements and the filtered phase flows out through channels formed by means of the central perforations; a base plate and a cover plate, between which the stacks with the film elements are arranged and distinguished by means of the base plate, showing guiding channels aligned with the perforations of the film elements for the soiled phase, and that the cover plate shows guiding channels for the filtered phase as well as an outlet for the clean phase and air channels for the air cleaning of the dirty channels between the ring stacks of the film elements; and a preloading device is provided for between the base plate and cover plate, by means of which the pressure on the stacks with their film elements can be regulated.

7. The filter according to one of the previous claims, wherein all the film elements lying on the same level being connected to each other by means of connecting fillets.

8. The filter according to one of the previous claims, is distinguished, by the film elements lying on the cutting points of the grid lines, and the connecting fillets on the grid lines of a rectangular, particularly square grid net.

9. The filter according to one of the previous claims, is distinguished, by the film elements as well as the connecting fillets being punched out of a single sheet of film.
